(19) United States
(12) Patent Application Publication
(10) Pub. No.: US 2025/0310785 A1
(43) Pub. Date: Oct. 2, 2025

(54) COLLABORATION FOR SENSING DIRECTIONAL INTRACELL INTERFERENCE

(71) Applicant: QUALCOMM Incorporated, San Diego, CA (US)

(72) Inventors: Aviv REGEV, Tel aviv (IL); Ronen SHAKED, Kfar Saba (IL); Shay LANDIS, Hod Hasharon (IL)

(21) Appl. No.: 18/623,471

(22) Filed: Apr. 1, 2024

(51) Int. Cl. H04W 16/28; H04B 17/336; H04W 8/22; H04W 24/10

(52) U.S. Cl. CPC H04W 16/28; H04B 17/336; H04W 8/22; H04W 24/10

(57) ABSTRACT

Methods, systems, and devices for wireless communications are described. A user equipment (UE) may receive a control message including an indication of one or more resources for measuring directional intracell interference information. The UE may transmit an intracell interference information report based at least in part on one or more directional intracell interference measurements corresponding to the one or more resources. The UE may receive a beam configuration message comprising an instruction to perform null steering for one or more beams based at least in part on the intracell interference information report.

### FIELD OF TECHNOLOGY

The following relates to wireless communications, including collaboration for sensing directional intracell interference.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support collaboration for sensing directional intracell interference. For example, the described techniques provide for a user equipment (UE) receiving a control message including an indication of one or more resources for measuring directional intracell interference information. The UE may transmit an intracell interference information report based on one or more directional intracell interference measurements corresponding to the one or more resources. The UE may receive a beam configuration message including an instruction to perform null steering for one or more beams based on the intracell interference information report.

A method for wireless communications by a UE is described. The method may include receiving a control message including an indication of one or more resources for measuring directional intracell interference information, transmitting an intracell interference information report based on one or more directional intracell interference measurements corresponding to the one or more resources, and receiving a beam configuration message including an instruction to perform null steering for one or more beams based on the intracell interference information report.

A UE for wireless communications is described. The UE may include one or more memories storing processor executable code, and one or more processors coupled with the one or more memories. The one or more processors may individually or collectively be operable to execute the code to cause the UE to receive a control message including an indication of one or more resources for measuring directional intracell interference information, transmit an intracell interference information report based on one or more directional intracell interference measurements corresponding to the one or more resources, and receive a beam configuration message including an instruction to perform null steering for one or more beams based on the intracell interference information report.

Another UE for wireless communications is described. The UE may include means for receiving a control message including an indication of one or more resources for measuring directional intracell interference information, means for transmitting an intracell interference information report based on one or more directional intracell interference measurements corresponding to the one or more resources, and means for receiving a beam configuration message including an instruction to perform null steering for one or more beams based on the intracell interference information report.

A non-transitory computer-readable medium storing code for wireless communications is described. The code may include instructions executable by one or more processors to receive a control message including an indication of one or more resources for measuring directional intracell interference information, transmit an intracell interference information report based on one or more directional intracell interference measurements corresponding to the one or more resources, and receive a beam configuration message including an instruction to perform null steering for one or more beams based on the intracell interference information report.

Some examples of the method, UEs, and non-transitory computer-readable medium described herein may further include operations, features, means, or instructions for receiving, via the control message, an instruction for the UE to perform direction of arrival (DOA) measurements via the one or more resources for measuring directional intracell interference information.

Some examples of the method, UEs, and non-transitory computer-readable medium described herein may further include operations, features, means, or instructions for detecting an uplink measurement signal transmitted by a second UE via the one or more resources for measuring directional intracell interferences information and performing the one or more directional intracell interference measurements including the DOA measurements according to the instruction for the UE to perform the DOA measurements and based on detecting the uplink measurement signal.

Some examples of the method, UEs, and non-transitory computer-readable medium described herein may further include operations, features, means, or instructions for transmitting, via the intracell interference information report, an indication of an estimated DOA associated with the uplink measurement signal according to the DOA measurements, where the beam configuration message may be based on the estimated DOA.

Some examples of the method, UEs, and non-transitory computer-readable medium described herein may further include operations, features, means, or instructions for receiving, via the control message, an indication for the UE to transmit an uplink measurement signal via the one or more resources for measuring directional intracell interference information and transmitting the uplink measurement signal via the one or more resources for measuring directional intracell interference information, where the one or more directional intracell interference measurements may be based on the uplink measurement signal.

Some examples of the method, UEs, and non-transitory computer-readable medium described herein may further include operations, features, means, or instructions for receiving a capability request message including a request for a UE capability report associated with a null steering capability at the UE.

Some examples of the method, UEs, and non-transitory computer-readable medium described herein may further include operations, features, means, or instructions for transmitting a UE capability report associated with the null steering capability at the UE according to the capability request message, where receiving the control message including the indication of the one or more resources for measuring directional intracell interference information may be based on the UE capability report.

In some examples of the method, UEs, and non-transitory computer-readable medium described herein, the UE capability report includes a threshold quantity of directions in which the UE may be capable of performing null steering and the beam configuration message including an instruction to perform null steering for the one or more beams may be based on the threshold quantity of directions.

In some examples of the method, UEs, and non-transitory computer-readable medium described herein, the UE capability report includes a threshold width of a candidate null steered beam and the beam configuration message including an instruction to perform null steering for the one or more beams may be based on the threshold width.

Some examples of the method, UEs, and non-transitory computer-readable medium described herein may further include operations, features, means, or instructions for performing null steering for the one or more beams based on the intracell interference information report.

A method for wireless communications by a network entity is described. The method may include outputting, to a UE, a control message including an indication of one or more resources for measuring directional intracell interference information, obtaining an intracell interference information report based on one or more directional intracell interference measurements corresponding to the one or more resources, and outputting a beam configuration message including an instruction to perform null steering for one or more beams based on the intracell interference information report.

A network entity for wireless communications is described. The network entity may include one or more memories storing processor executable code, and one or more processors coupled with the one or more memories. The one or more processors may individually or collectively be operable to execute the code to cause the network entity to output, to a UE, a control message including an indication of one or more resources for measuring directional intracell interference information, obtain an intracell interference information report based on one or more directional intracell interference measurements corresponding to the one or more resources, and output a beam configuration message including an instruction to perform null steering for one or more beams based on the intracell interference information report.

Another network entity for wireless communications is described. The network entity may include means for outputting, to a UE, a control message including an indication of one or more resources for measuring directional intracell interference information, means for obtaining an intracell interference information report based on one or more directional intracell interference measurements corresponding to the one or more resources, and means for outputting a beam configuration message including an instruction to perform null steering for one or more beams based on the intracell interference information report.

A non-transitory computer-readable medium storing code for wireless communications is described. The code may include instructions executable by one or more processors to output, to a UE, a control message including an indication of one or more resources for measuring directional intracell interference information, obtain an intracell interference information report based on one or more directional intracell interference measurements corresponding to the one or more resources, and output a beam configuration message including an instruction to perform null steering for one or more beams based on the intracell interference information report.

Some examples of the method, network entities, and non-transitory computer-readable medium described herein may further include operations, features, means, or instructions for sensing for directional intracell interference associated with one or more UEs based on the intracell interference information report, where the beam configuration message may be based on the sensing.

Some examples of the method, network entities, and non-transitory computer-readable medium described herein may further include operations, features, means, or instructions for outputting, via the control message, an instruction for the UE to perform DOA measurements via the one or more resources for measuring directional intracell interference information.

Some examples of the method, network entities, and non-transitory computer-readable medium described herein may further include operations, features, means, or instructions for obtaining, via the intracell interference information report, an indication of an estimated DOA according to the DOA measurements, where the beam configuration message may be based on the estimated DOA.

Some examples of the method, network entities, and non-transitory computer-readable medium described herein may further include operations, features, means, or instructions for outputting, via the control message, an indication for the UE to transmit an uplink measurement signal via the one or more resources for measuring directional intracell interference information.

Some examples of the method, network entities, and non-transitory computer-readable medium described herein may further include operations, features, means, or instructions for outputting a capability request message including a request for a UE capability report associated with a null steering capability at the UE.

Some examples of the method, network entities, and non-transitory computer-readable medium described herein may further include operations, features, means, or instructions for obtaining a UE capability report associated with the null steering capability at the UE according to the capability request message, where outputting the control message including the indication of the one or more resources for measuring directional intracell interference information may be based on the UE capability report.

In some examples of the method, network entities, and non-transitory computer-readable medium described herein, the UE capability report includes, a threshold quantity of directions in which the UE may be capable of performing null steering and the beam configuration message including an instruction to perform null steering for one or more beams may be based on the threshold quantity of directions.

In some examples of the method, network entities, and non-transitory computer-readable medium described herein, the UE capability report includes, a threshold width of a candidate null steered beam and the beam configuration message including an instruction to perform null steering for one or more beams may be based on the threshold width.

### BRIEF DESCRIPTION OF THE DRAWINGS

FIG. 1 shows an example of a wireless communications system that supports collaboration for sensing directional intracell interference in accordance with one or more aspects of the present disclosure.

FIG. 2 shows an example of a wireless communications system that supports collaboration for sensing directional intracell interference in accordance with one or more aspects of the present disclosure.

FIG. 3 shows an example of a process flow that supports collaboration for sensing directional intracell interference in accordance with one or more aspects of the present disclosure.

FIGS. 4 and 5 show block diagrams of devices that support collaboration for sensing directional intracell interference in accordance with one or more aspects of the present disclosure.

FIG. 6 shows a block diagram of a communications manager that supports collaboration for sensing directional intracell interference in accordance with one or more aspects of the present disclosure.

FIG. 7 shows a diagram of a system including a device that supports collaboration for sensing directional intracell interference in accordance with one or more aspects of the present disclosure.

FIGS. 8 and 9 show block diagrams of devices that support collaboration for sensing directional intracell interference in accordance with one or more aspects of the present disclosure.

FIG. 10 shows a block diagram of a communications manager that supports collaboration for sensing directional intracell interference in accordance with one or more aspects of the present disclosure.

FIG. 11 shows a diagram of a system including a device that supports collaboration for sensing directional intracell interference in accordance with one or more aspects of the present disclosure.

FIGS. 12 through 16 show flowcharts illustrating methods that support collaboration for sensing directional intracell interference in accordance with one or more aspects of the present disclosure.

### DETAILED DESCRIPTION

In some wireless communications systems, a network entity may communicate with a set of user equipments (UEs) each using a respective beam configuration. The network entity may support multiple-user multiple-input multiple-output (MU-MIMO) communication and time division (TD) multiplexing and frequency division (FD) multiplexing to communicate with the set of UEs. The MU-MIMO communications by the network entity may include transmitting and receiving data to and from multiple UEs in the set of UEs during the same time and frequency resources (e.g., in a full-duplex system). For example, the network entity may transmit a downlink signal to a first UE at a first time and frequency resource and a second UE may transmit an uplink signal to the network entity at the first time and frequency resource. The uplink signal from the second UE may cause intracell interference at the first UE. For instance, the first UE may be monitoring for the downlink signal during the first time and frequency resources, and may inadvertently detect some or all of the uplink signal transmitted by the UE during the same time and frequency resources. In other words, the multiple transmissions during the same time and frequency resource may cause intracell interference between the multiple transmissions. The intracell interference may limit attainable signal-to-noise ratio (SNR) and data rates. Such intracell interference may depend on beam directions. For example, if a transmit beam for transmitting the uplink signal by the second UE is directed towards the first UE, then the first UE may experience higher levels of intracell interference via that transmit beam at the second UE (e.g., but may experience no intracell interference in the full duplex system if a transmit beam at the second UE is pointed in a different direction).

According to techniques described herein, the network entity may sense or predict intracell interference and reduce the levels of intracell interference by changing the beam configuration at one or more UEs in the set of UEs. For example, the network entity may transmit a control message indicating one or more resources (e.g., dedicated slots) for intracell interference detection to one or more UEs in the set of UEs. The control message may indicate for a first UE of the set of UEs to perform an uplink transmission via the one or more resources. The control message may indicate for one or more UEs in the set of UEs to measure or estimate the direction of arrival (DOA) associated with the uplink transmission via the one or more measurement resources. The one or more UEs may transmit an intracell interference information report to the network entity. The network entity may sense or predict intracell interference at the UEs based on the intracell interference information reports. If the network entity predicts intracell interference between one or more UEs, the network entity may transmit an indication of an updated beam configuration to one or more interfering UEs (e.g., one or more UEs that cause intracell interference at other UEs). In some cases, if the interfering UE supports null steering (e.g., ensuring that transmissions do not occur in a particular direction or a using a particular beam), the beam configuration may indicate for the interfering UE to perform null steering on one or more interfering beams. In some cases, the beam configuration may indicate a new beam configuration for the interfering UE. Such UEs may perform the null steering (e.g., may avoid transmitting in some directions or via some beams), and the intracell interference may be mitigated, reduced, or avoided.

Aspects of the disclosure are initially described in the context of wireless communications systems. Aspects of the disclosure are further illustrated by and described with reference to apparatus diagrams, system diagrams, and flowcharts that relate to collaboration for sensing directional intracell interference.

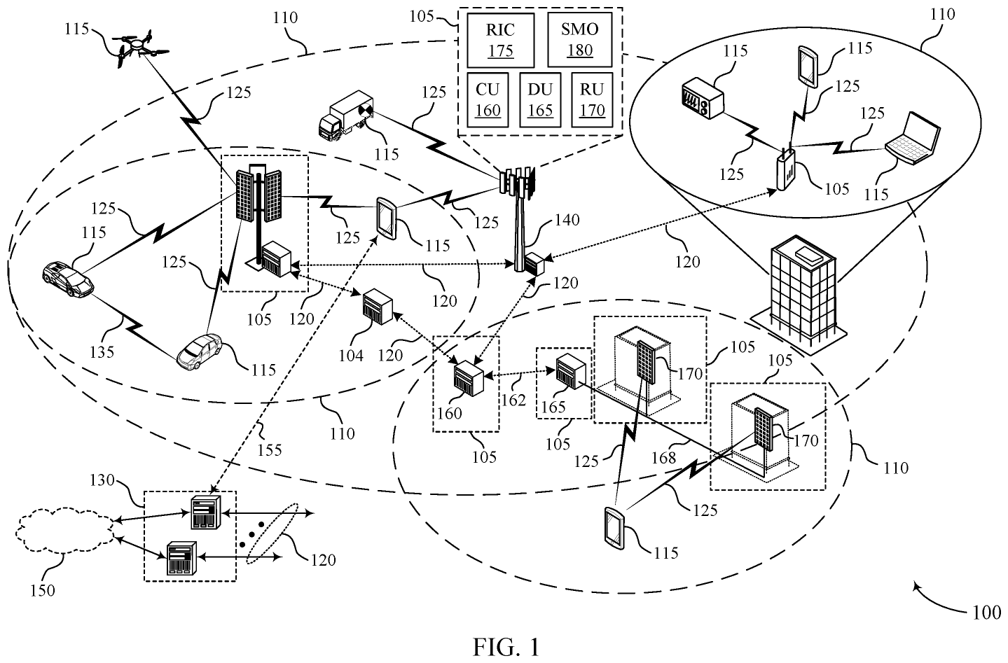

FIG. 1 shows an example of a wireless communications system 100 that supports collaboration for sensing directional intracell interference in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUS 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both FD duplexing (FDD) and TD duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal FD multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of TD multiplexing (TDM) techniques, FD multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and MU-MIMO, for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest SNR, or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

According to techniques described herein, the network entity 105 may sense or predict intracell interference and reduce the levels of intracell interference by changing the beam configuration at one or more UEs 115 in the set of UEs 115. For example, the network entity 105 may transmit a control message indicating one or more resources (e.g., dedicated slots) for intracell interference detection to one or more UEs 115 in the set of UEs 115. The control message may indicate for a first UE 115 of the set of UEs 115 to perform an uplink transmission via the one or more resources. The control message may indicate for one or more UEs 115 in the set of UEs 115 to measure or estimate the DOA associated with the uplink transmission via the one or more resources. The one or more UEs 115 may transmit an intracell interference information report to the network entity 105. The network entity 105 may sense or predict intracell interference at the UEs 115 based on the intracell interference information reports. If the network entity 105 predicts intracell interference, the network entity 105 may transmit a beam configuration to one or more interfering UEs 115 (e.g., one or more UEs 115 that cause intracell interference at other UEs 115). In some cases, if the interfering UE 115 supports null steering, the beam configuration may indicate for the interfering UE 115 to perform null steering on one or more interfering beams. In some cases, the beam configuration may indicate a new beam configuration for the interfering UE 115.

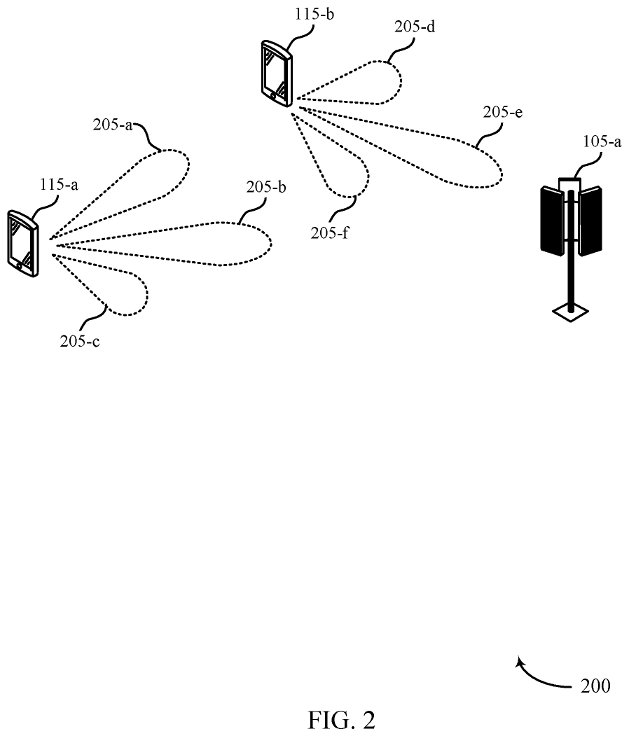

FIG. 2 shows an example of a wireless communications system 200 that supports collaboration for sensing directional intracell interference in accordance with one or more aspects of the present disclosure. In some examples, wireless communications system 200 may implement aspects of wireless communications system 100. For example, a UE 115-a and a UE 115-b may represent an example of a UE, such as the UEs 115 described with reference to FIG. 1. The network entity 105-a may represent an example of a network entity, such as the network entity 105 described with reference to FIG. 1. The UE 115-a may communicate via beam 205-a, beam 205-b, or beam 205-c. The UE 115-b may communicate via beam 205-d, beam 205-e, or beam 205-f. The UE 115-a and the UE 115-b may be served by the network entity 105-a.

In some wireless communications systems, the network entity 105-a may serve multiple UEs 115 (e.g., UE 115-a and UE 115-b). In some cases, the multiple UEs 115 may be associated with a cell. In order to service the multiple UEs, the network entity may implement MU-MIMO communication. The network entity may use the same TD or FD resources to communicate (e.g., transmit or receive) data with the multiple UEs 115. In some examples, MU-MIMO communication may enable concurrent or simultaneous one-to-many transmissions. In that way the network entity 105-a may more efficiently utilize (e.g., save up) available TD or FD resources, and the network entity 105-a may improve the spectral efficiency. In some cases, the MU-MIMO communication may raise the problem of intra-cell interference. For example, an uplink transmission at the UE 115-a may interfere with a downlink reception at the UE 115-b. The interference may limit attainable SNR in the wireless communications system (e.g., for one or more devices such as the UE 115-b), and the interference may limit the data rate for a downlink reception at the UE 115-b. In order to reduce the interference, the network entity 105-a may utilize elaborate spatial multiplexing mechanism which may suppress the interference (e.g., downlink or uplink interference). For example, the network entity 105-a may utilize dynamic time domain duplexing (TDD). The UE 115-a may transmit data (e.g., transmit uplink traffic) while the UE 115-b may receive data (e.g., receive downlink traffic).

However, utilizing dynamic TDD may still result in interference between the UEs 115. For example, in a full-duplex system (e.g., using the same TD and FD resources) MU-MIMO communication may result in an intracell interference problem. In the full duplex system, some or all UEs 115 may transmit and receive at the same time (e.g., in a MU-MIMO and full-duplex deployment). As a result, intracell interference may limit data rates for the downlink reception at the UEs 115 (e.g., regardless of the network entity 105-a utilizing dynamic TDD).

According to techniques described herein, the network entity 105-a may detect intracell interference scenarios in advance (e.g., may predict pending intracell interference scenarios) based on the sensing capabilities of the network entity 105-a, reporting by the UEs 115, or a combination thereof. The network entity 105-a may reduce, mitigate, or prevent intracell interference by transmitting a control signal to the interfering UE 115 instructing the interfering UE 115 to change beam properties in order to cancel or reduce the detected interference. That is, the network entity 105-a may transmit a control signal to the interfering UE 115 including a beam configuration message, which may indicate that the UE 115 is to change its beam configuration and refrain from transmission in one or more directions or via one or more beams.

In order to sense intracell interference, the network entity 105-a may map (e.g., based on sensing) beams 205 from multiple or all served UEs 115 and may seek intracell interference in the cell. If the network entity 105-a identifies (e.g., detects) interference, the network entity 105-a may transmit control signaling to the interfering UE 115 including an instruction to perform null steering in the direction of the interference. The UEs 115 may perform sensing procedures and measurement procedures to detect directional intracell interference, and may report sensed intracell interference, DOA estimation, etc. The network entity 105-a may (e.g., instead of, or in addition to the reported intracell interference) perform intracell interference sensing to detect directional intracell interference. In some examples, if the network entity 105-a senses (e.g., based on sensing, or reports) that the UE 115-a causes intracell interference on the beam 205-a (e.g., causing interference for the UE 115-b), the network entity 105-a may transmit a beam configuration message to the UE 115-a including an instruction to perform null steering on the beam 205-a (e.g., to steer transmissions away from the direction of the beam 205-a, to refrain from transmissions via the beam 205-a, to change the direction, width, or other dimensions of the beam 205-a, among other examples). In some examples, the network entity 105-a may transmit control signaling to the interfering UE 115-a to change the uplink transmit beam of the UE 115-a. In some examples, the network entity 105-a may choose another action to prevent the detected interference.

The sensing at the network entity 105-a may be especially suitable for supported wireless communications via specific frequency ranges or bands (e.g., higher bands like mmW frequencies ranging from 24 GHz to 100 GHz (FR2) and subTHz, where the non-line of sight (NLOS) beams has relatively low power due to the increased path loss). In some cases, intracell interference may come from a given direction, or several directions.

A cell associated with the network entity 105-a may include the UE 115-a and the UE 115-b and may use MU-MIMO communication. The network entity 105-a may transmit (e.g., MU-MIMO) downlink data to the UE 115-a and the UE 115-b. The UE 115-a and the UE 115-b may transmit uplink data to the network entity 105-a. In some cases, the UEs 115 may transmit uplink data to the network entity 105-a at the same time as the network entity 105-a transmits downlink data to the UEs 115. In some cases, transmitting the uplink data and the downlink data may cause intracell interference. For example, intracell interference may be an example of interference associated with an uplink transmission by the UE 115-a interfering with a downlink reception of the UE 115-b. That is, the UE 115-a may transmit uplink data using the beam 205-a, and the uplink data transmitted via the beam 205-a may interfere with the downlink reception at the UE 115-b (e.g., because the UE 115-b may detect or receive the uplink transmissions sent by the UE 115-a via the beam 205-a).

The network entity 105-a may transmit a beam configuration message including an instruction for the UE 115-a to perform null steering in the direction of the UE 115-b (e.g., perform null steering on beam 205-a). The null steering may prevent the intracell interference associated with the uplink transmission by the UE 115-a. For example, the network entity 105-a may instruct the UE 115-a to perform null steering for the interfering beam 205-a. The UE 115-a may remove the one or more beams (e.g., beam 205-a) that interfered with the UE 115-b. In other words, the one or more beams 205 that interfered with the downlink reception at the UE 115-b may no longer exist after the null steering procedure. If the UE 115-a does not have the capability to perform null steering, the network entity 105-a transmit a beam configuration message including an indication for the UE 115-a to replace the beam 205-a, refrain from transmission, utilize other beams, or the like.

The network entity 105-a may transmit a beam configuration message based on the network entity 105-a changing one of the served UEs 115 that may be using the same TD or FD resources in full-duplex (e.g., changing the UEs 115 that are served with MU-MIMO). The network entity 105-a may transmit the control message and beam configuration message based on an indication that a location associated with one of the UEs 115 has changed. Additionally, or alternatively, the network entity 105-a may transmit the beam configuration message based on a periodicity (e.g., a periodicity determined by the network entity).

That is, the network entity 105-a may sense the intracell interference in a cell and the UEs 115 (e.g., UE 115-a and UE 115-b) may preform null steering or change a transmit beam to prevent that interference based on signaling between the network entity 105-a and the UEs 115, in MU-MIMO communication.

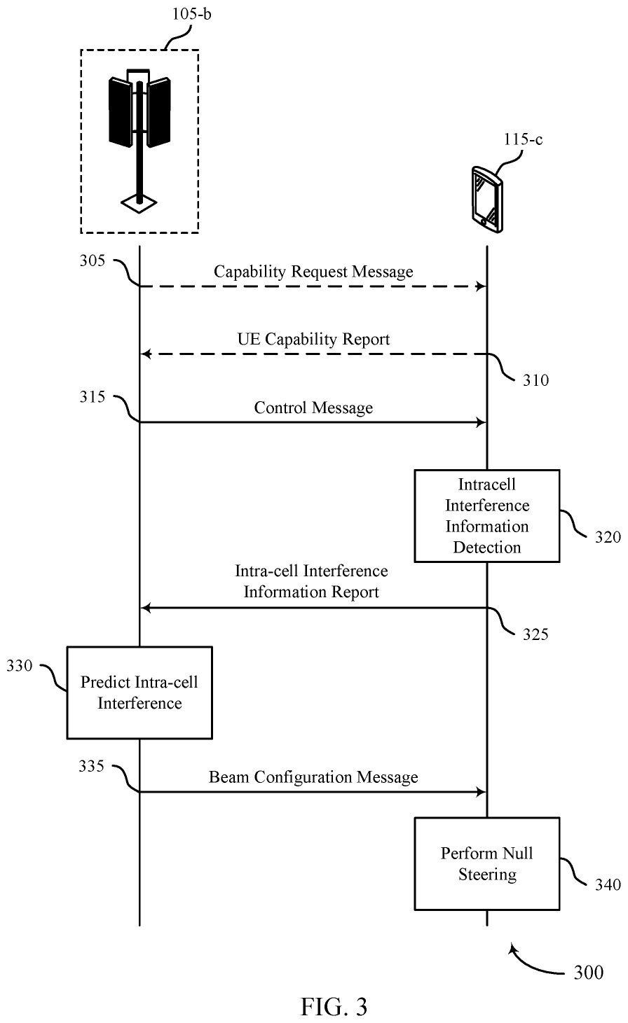

FIG. 3 shows an example of a process flow 300 that supports collaboration for sensing directional intracell interference in accordance with one or more aspects of the present disclosure. In some examples, process flow 300 may implement aspects of, or be implemented by aspects of, the wireless communication system 100 or the wireless communication system 200. For example, the process flow 300 may include a UE 115-c and a network entity 105-b which may be examples of corresponding devices described with reference to FIGS. 1 and 2.

At 305, the network entity 105-b may output (e.g., transmit) a capability request message including a request for a UE capability report associated with a null steering capability at the UE 115-c. The network entity my output the capability request message to a single UE 115 (e.g., the UE 115-c) or a group of UEs 115 (e.g., a group of UEs 115 including UE 115-c). That is, the network entity 105-a may send a request to the UE 115-c for sharing the null steering capability associated with the UE 115-c. In some cases, the request may be output via a medium access control (MAC) control element (MAC-CE) or radio resource control (RRC) message (e.g., at the beginning of the communication or after cell-attachment).

At 310, the UE 115-c may transmit the UE capability report associated with the null steering capability at the UE 115-c according to the capability request message. That is, the UE 115-c may reply to the capability request message output by the network entity 105-b. The capability report message may indicate whether the UE 115-c has the null steering capability or the UE 115-c lacks the null steering capability. If the UE has the null steering capability, the UE capability report may include information regarding the null steering capability at the UE 115-c. In some cases, the UE capability report may include a threshold quantity of directions in which the UE 115-c may be capable of performing null steering (e.g., a maximum number of directions (e.g., N directions) in which the UE 115-c is capable of producing a null beam or performing null steering). In some cases, the UE capability report may include a threshold width of a candidate null steered beam (e.g., a maximum width or delta in degrees of each null beam the UE 115-c is capable of generating or each direction in which the UE 115-c is capable of performing null steering). The threshold quantity of directions (e.g., maximum number of directions) or the threshold quantity of directions (e.g., the maximum width or delta in degrees) may be based on the quantity of transmit antennas at the UE 115-c. In some cases, the UE 115-c may indicate if the UE 115-c has DOA estimation capabilities in the UE capability report. The DOA capabilities may be used to aid the network entity 105-b with the intracell interference sensing procedure (e.g., at 330). For example, the UE 115-c may transmit a UE capability report indicating that the UE 115-c has null steering and DOA estimation capabilities.

The UE capability report may be transmitted via a MAC-CE at the beginning of communication or after attachment (e.g., cell attachment). If the UE null steering capabilities change for some reason (e.g., the UE 115-c enters a low battery mode, the quantity of transmit antennas changes, etc.), the UE 115-c may update the capability report via the physical level (e.g., via uplink control information (UCI) as part of the physical uplink control channel (PUCCH)). The UE 115-c may autonomously update the UE capability report (e.g., may detect a triggering condition such as a change, and may transmit an updated capability report) or the UE 115-c may be configured to periodically transmit an updated capability report, or the network entity 105-b may trigger an updated capability report, among other examples.

In some cases, the network entity 105-b may already have access to the capability information associated with the UE 115-c (e.g., the UE 115-c may have previously transmitted the capability report). The network entity 105-b may refrain from transmitting the request for UE capability request message based on already having access to the capability information associated with the UE 115-c.

At 315, the network entity 105-b may output a control message including an indication of one or more resources (e.g., dedicated slots) for measuring directional intracell interference information. The network entity my output the control message to a single UE 115 (e.g., the UE 115-c) or a group of UEs 115 (e.g., a group of UEs 115 including UE 115-c). In some cases, the UE 115-c may receive, via the control message, an instruction for the UE 115-c to perform DOA measurements via the one or more resources for measuring directional intracell interference information. In some cases, the UE 115-c may receive the control message including the indication of the one or more resources for measuring directional intracell interference information may be based on the UE capability report. For example, the UE 115-c may receive the control message based on the UE 115-c indicating, via the capability report, that the UE 115-c has DOA estimation capabilities.

The network entity 105-b may request for additional information (e.g., via the control message) regarding the intracell interference in the cell associated with the network entity 105-b. In some cases, the request for additional information may be based on if the UE 115-c indicated that the UE 115-c has DOA estimation capabilities (e.g., via the capability report). For example, the control message, may include a request for one or more UEs 115 in the group of UEs 115 to search the DOA in dedicated slots. The control message may include an indication of the dedicated slot or the dedicated slots may be preconfigured. In the dedicated slots the network entity 105-b may command (e.g., indicate via an instruction in the control message) for a single UE 115 to transmit uplink data (e.g., an uplink measurement signal) and the other UEs 115 to be in listening mode and avoid transmission (e.g., the other UEs 115 may search for a DOA associated with the uplink transmission at the single UE 115, and the other UEs 115 may not transmit data). That is, the network entity 105-a may indicate for the single UE 115 to transmit an uplink measurement signal during the one or more resources (e.g., dedicated slots), and the network entity 105-a may indicate for the other UEs 115 to estimate the DOA associated with the uplink transmission at the single UE 115. The UE 115-c may be an example of the single transmitting UE 115 or one of the other listening mode UEs 115. Additionally, or alternatively, the network entity 105-b may request (e.g., via the control message) for the UE 115-c to share the location associated with the UE 115-c. The network entity 105-a may output the control message via the physical level (e.g., via downlink control information (DCI) as part of the physical downlink control channel (PDCCH)).

In some cases, at 320, the UE 115-c may detect an uplink measurement signal transmitted by a second UE 115 (e.g., the single transmitting UE) via the one or more resources for measuring directional intracell interferences information. The UE 115-c may perform the one or more directional intracell interference measurements including the DOA measurements according to the instruction for the UE 115-c to perform the DOA measurements and based on detecting the uplink measurement signal. For example, the UE 115-c may be an example of one of the other listening mode UEs 115. The UE 115-c may receive the uplink data from the single transmitting UE 115 via the dedicated slots, and the UE 115-c may estimate the DOA associated with the uplink transmission. The UE 115-c may estimate the DOA associated with the uplink transmission based on the one or more directional intracell interference measurements.

In some cases, at 320, the UE 115-c may receive, via the control message, an indication for the UE 115-c to transmit an uplink measurement signal via the one or more resources for measuring directional intracell interference information. The UE 115-c may transmit the uplink measurement signal via the one or more resources for measuring directional intracell interference information. The one or more directional intracell interference measurements may be based on the uplink measurement signal. For example, the UE 115-c may be an example of the single transmitting UE 115. The UE 115-c may transmit the uplink data to the other listening mode UEs 115 via the dedicated slots, and the other listening mode UEs 115 may estimate the DOA associated with the uplink transmission. The other listening mode UEs 115 may estimate the DOA associated with the uplink transmission based on the one or more directional intracell interference measurements.

At 325, the UE 115-c may transmit an intracell interference information report based on one or more directional intracell interference measurements corresponding to the one or more resources. In some cases, the UE 115-c may transmit, via the intracell interference information report, an indication of an estimated DOA associated with the uplink measurement signal according to the DOA measurements. For example, the UE 115-c may response to the control message output by the network entity 105-b. The UE 115-c may first perform DOA estimation (e.g., minimum variance distortion less response (MVDR), multiple signal classification (MUSIC), etc.). Then the UE 115-c may transmit the DOA estimation via uplink. In some cases, the UE 115 may indicate the power of the signal (e.g., a received signal strength indicator (RSSI)) via the intracell interference information report (e.g., DOA message). The power of the signal may be associated with the estimated DOA. The UE 115-c may transmit the intracell interference information report via the physical level (e.g., via UCI as part of the PUCCH).

At 330, the network entity 105-b may sense for directional intracell interference associated with one or more UEs 115 based on the intracell interference information report. The one or more UEs 115 may be served by the same resources (e.g., MU-MIMO communication). For example, the network entity 105-b may preform sensing for intracell interference in an area associated with a cell. The network entity 105-b may sense the area of the UEs 115 that are served by MU-MIMO communication. The sensing may be aided by the intracell interference information report indicated by the UEs 115. The network entity 105-b may (e.g., instead of, or in addition to the reported intracell interference) perform intracell interference sensing to detect directional intracell interference. The sensing may be aided by radar that detects the different beams associated with the UEs 115. The network entity 105-b may use advanced machine learning sensing tools to learn the cell's environment.

After the sensing the network entity 105-b may generate a map of interferences among the UEs 115 that are served with the same resources. The network entity 105-b may generate the map based on the intracell interference information report received from the UEs 115 or the sensing at the network entity 105-b. The network entity 105-b may determine if there is an interference that is limiting the noise floor (e.g., in the same order of magnitude of the reported SNR).

At 335, The network entity may prevent, mitigate, or reduce the interference by transmitting a beam configuration message instructing (e.g., commanding) the interfering UE 115 to perform null steering in the direction of the interference. If the UE 115 does not have the capability to perform null signaling, the network entity 105-b may transmit a beam configuration message instructing the interfering UE 115 to change the transmit beam associated with the interfering UE 115. For example, if the network entity 105-b senses that the UE 115-c is generating intracell interference on a first beam, the network entity 105-b may transmit a beam configuration message instructing the UE 115-c to perform null steering on the first beam.

For example, the network entity 105-b may output a beam configuration message including an instruction to perform null steering for one or more beams based on the intracell interference information report. In some cases, the beam configuration message may be based on the sensing. In some cases, the beam configuration message may be based on the estimated DOA. In some cases, the beam configuration message including an instruction to perform null steering for the one or more beams may be based on the threshold quantity of directions or the threshold width. The network entity 105-b may indicate an instruction to the UE 115-c based on the sensing for directional intracell interference.

In some cases, the UE 115-c may perform a second DOA estimation (e.g., MVDR, MUSIC, etc.). The UE 115-c may transmit the second DOA estimation. In some cases, the UE 115-c may transmit the second DOA estimation message over the physical level (e.g., UCI as part of the PUCCH). In some cases, the second DOA estimation message may be included in a second intracell interference report.

At 340, the UE 115-c may perform the operation commanded by the network entity 105-b at 335. For example, the UE 115-c may perform null steering for the one or more beams based on the intracell interference information report. For example, the network entity 105-b may instruct the UE 115-c to perform null steering on a first beam. The network entity 105-b may reduce intercell interference at a second UE 115 based on the UE 115-c performing null steering on the first beam.

In some examples, the network entity 105-b may perform one or more of the operations described herein multiple times. For instance, each time there is a change in coverage, location, or position, among other examples, the network entity 105-b may transmit another capability request message to a UE 115-c that has changed its physical location (e.g., based on a report from the UE 115-c of a changed or updated location). In some examples, if a new UE 115-c enters a coverage area served by the network entity 105-b, the network entity 105-b may transmit a capability request message to the UE 115-c. In some examples, each UE 115-c that changes location may autonomously transmit another UE capability report, or an updated intracell interference information report, or both. In some examples, the network entity 105-b may request updated reporting of intracell interference information, updated UE capability reporting, or a combination thereof, and may transmit an updated beam configuration message each time there is a change in quantity or position of served UEs that share resources (e.g., time and frequency resources in a full duplex mode), or each time there is a change in UEs that are served according to an MU-MIMO deployment. In some examples, the network entity 105-b may periodically repeat one or more operations described with reference to FIG. 3 dynamically (e.g., based at least in part on reports from the UEs 115-c or detected mobility changes, or changes in served UEs 115), or periodically. For instance, the network entity 105-b may indicate a periodicity to the UE 115-c at which to report its intracell interference information reports, or may periodically transmit the control message triggering another intracell interference report.

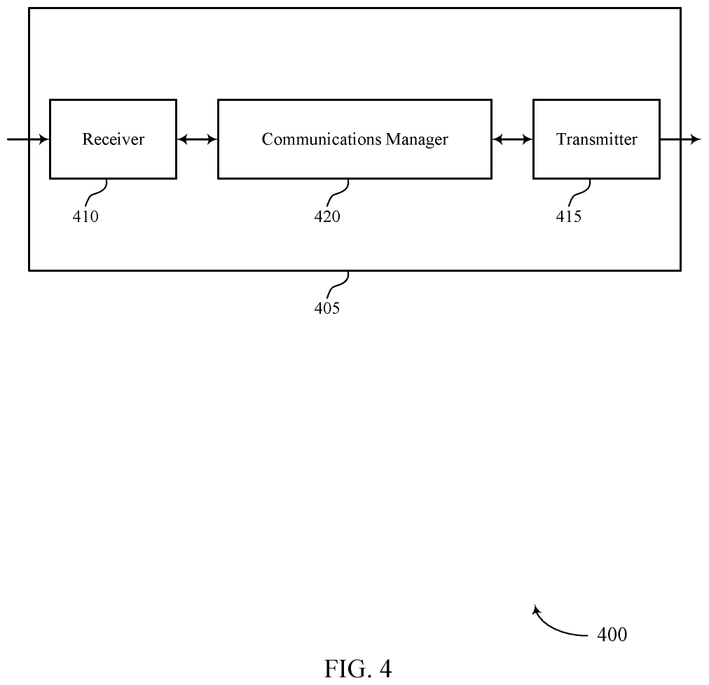

FIG. 4 shows a block diagram 400 of a device 405 that supports collaboration for sensing directional intracell interference in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to collaboration for sensing directional intracell interference). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to collaboration for sensing directional intracell interference). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of collaboration for sensing directional intracell interference as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for receiving a control message including an indication of one or more resources for measuring directional intracell interference information. The communications manager 420 is capable of, configured to, or operable to support a means for transmitting an intracell interference information report based on one or more directional intracell interference measurements corresponding to the one or more resources. The communications manager 420 is capable of, configured to, or operable to support a means for receiving a beam configuration message including an instruction to perform null steering for one or more beams based on the intracell interference information report.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for more efficient utilization of communication resources and the like.

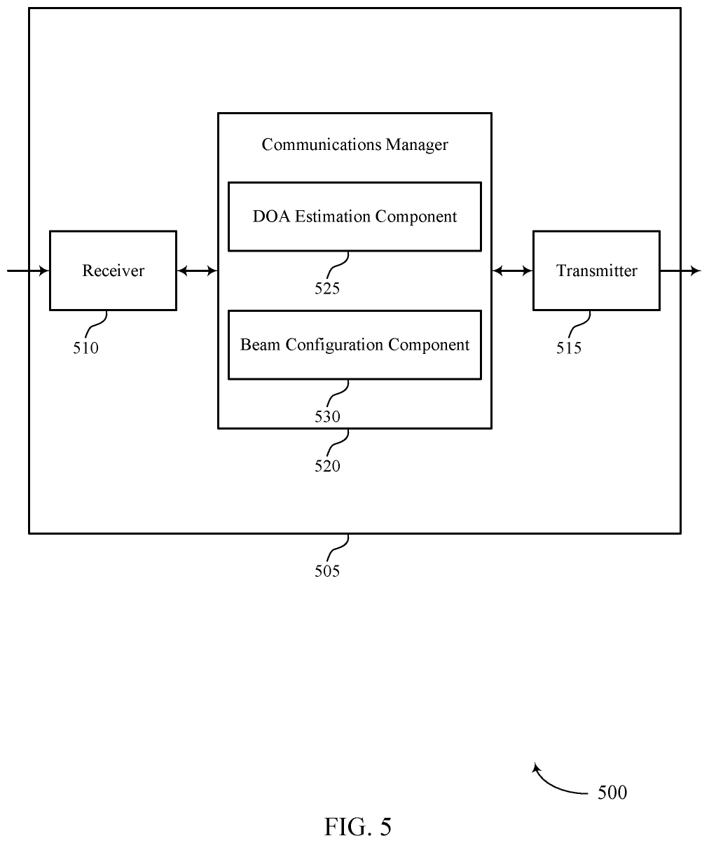

FIG. 5 shows a block diagram 500 of a device 505 that supports collaboration for sensing directional intracell interference in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to collaboration for sensing directional intracell interference). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to collaboration for sensing directional intracell interference). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of collaboration for sensing directional intracell interference as described herein. For example, the communications manager 520 may include a DOA estimation component 525 a beam configuration component 530, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The DOA estimation component 525 is capable of, configured to, or operable to support a means for receiving a control message including an indication of one or more resources for measuring directional intracell interference information. The DOA estimation component 525 is capable of, configured to, or operable to support a means for transmitting an intracell interference information report based on one or more directional intracell interference measurements corresponding to the one or more resources. The beam configuration component 530 is capable of, configured to, or operable to support a means for receiving a beam configuration message including an instruction to perform null steering for one or more beams based on the intracell interference information report.

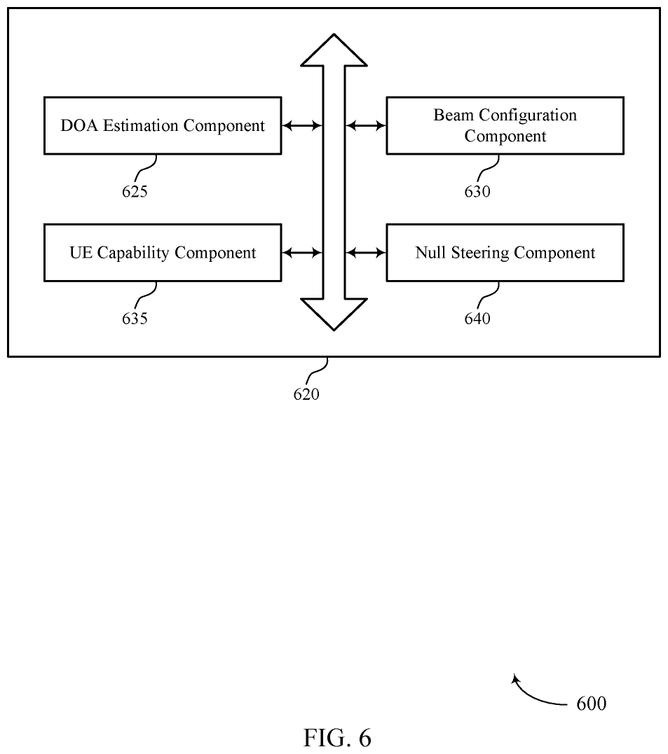

FIG. 6 shows a block diagram 600 of a communications manager 620 that supports collaboration for sensing directional intracell interference in accordance with one or more aspects of the present disclosure. The communications manager 620 may be an example of aspects of a communications manager 420, a communications manager 520, or both, as described herein. The communications manager 620, or various components thereof, may be an example of means for performing various aspects of collaboration for sensing directional intracell interference as described herein. For example, the communications manager 620 may include a DOA estimation component 625, a beam configuration component 630, a UE capability component 635, a null steering component 640, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The DOA estimation component 625 is capable of, configured to, or operable to support a means for receiving a control message including an indication of one or more resources for measuring directional intracell interference information. In some examples, the DOA estimation component 625 is capable of, configured to, or operable to support a means for transmitting an intracell interference information report based on one or more directional intracell interference measurements corresponding to the one or more resources. The beam configuration component 630 is capable of, configured to, or operable to support a means for receiving a beam configuration message including an instruction to perform null steering for one or more beams based on the intracell interference information report.

In some examples, the DOA estimation component 625 is capable of, configured to, or operable to support a means for receiving, via the control message, an instruction for the UE to perform DOA measurements via the one or more resources for measuring directional intracell interference information.

In some examples, the DOA estimation component 625 is capable of, configured to, or operable to support a means for detecting an uplink measurement signal transmitted by a second UE via the one or more resources for measuring directional intracell interferences information. In some examples, the DOA estimation component 625 is capable of, configured to, or operable to support a means for performing the one or more directional intracell interference measurements including the DOA measurements according to the instruction for the UE to perform the DOA measurements and based on detecting the uplink measurement signal.

In some examples, the DOA estimation component 625 is capable of, configured to, or operable to support a means for transmitting, via the intracell interference information report, an indication of an estimated DOA associated with the uplink measurement signal according to the DOA measurements, where the beam configuration message is based on the estimated DOA.

In some examples, the DOA estimation component 625 is capable of, configured to, or operable to support a means for receiving, via the control message, an indication for the UE to transmit an uplink measurement signal via the one or more resources for measuring directional intracell interference information. In some examples, the DOA estimation component 625 is capable of, configured to, or operable to support a means for transmitting the uplink measurement signal via the one or more resources for measuring directional intracell interference information, where the one or more directional intracell interference measurements are based on the uplink measurement signal.

In some examples, the UE capability component 635 is capable of, configured to, or operable to support a means for receiving a capability request message including a request for a UE capability report associated with a null steering capability at the UE.

In some examples, the UE capability component 635 is capable of, configured to, or operable to support a means for transmitting a UE capability report associated with the null steering capability at the UE according to the capability request message, where receiving the control message including the indication of the one or more resources for measuring directional intracell interference information is based on the UE capability report.

In some examples, the UE capability report includes a threshold quantity of directions in which the UE is capable of performing null steering. In some examples, the beam configuration message including an instruction to perform null steering for the one or more beams is based on the threshold quantity of directions.

In some examples, the UE capability report includes a threshold width of a candidate null steered beam. In some examples, the beam configuration message including an instruction to perform null steering for the one or more beams is based on the threshold width.

In some examples, the null steering component 640 is capable of, configured to, or operable to support a means for performing null steering for the one or more beams based on the intracell interference information report.

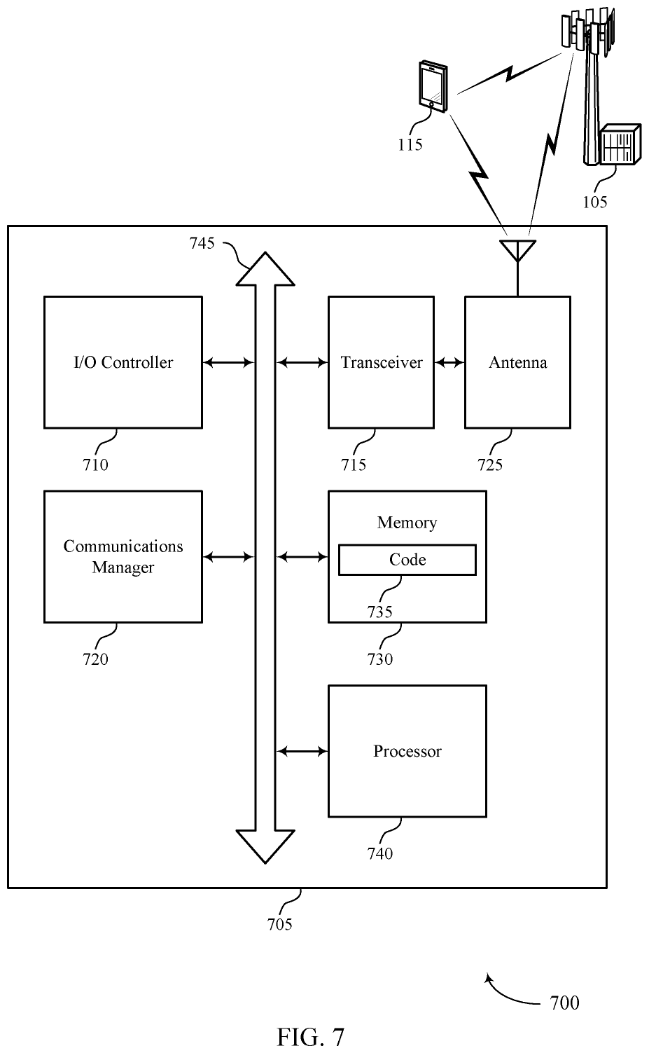

FIG. 7 shows a diagram of a system 700 including a device 705 that supports collaboration for sensing directional intracell interference in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more central processing units (CPUs), one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting collaboration for sensing directional intracell interference). For example, the device 705 or a component of the device 705 may include at least one processor 740 and at least one memory 730 coupled with or to the at least one processor 740, the at least one processor 740 and the at least one memory 730 configured to perform various functions described herein. In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for receiving a control message including an indication of one or more resources for measuring directional intracell interference information. The communications manager 720 is capable of, configured to, or operable to support a means for transmitting an intracell interference information report based on one or more directional intracell interference measurements corresponding to the one or more resources. The communications manager 720 is capable of, configured to, or operable to support a means for receiving a beam configuration message including an instruction to perform null steering for one or more beams based on the intracell interference information report.

By including or configuring the communications manager 720 in accordance with examples as described herein, the device 705 may support techniques for improved communication reliability, reduced latency, more efficient utilization of communication resources, improved coordination between devices, and the like.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of collaboration for sensing directional intracell interference as described herein, or the at least one processor 740 and the at least one memory 730 may be otherwise configured to, individually or collectively, perform or support such operations.

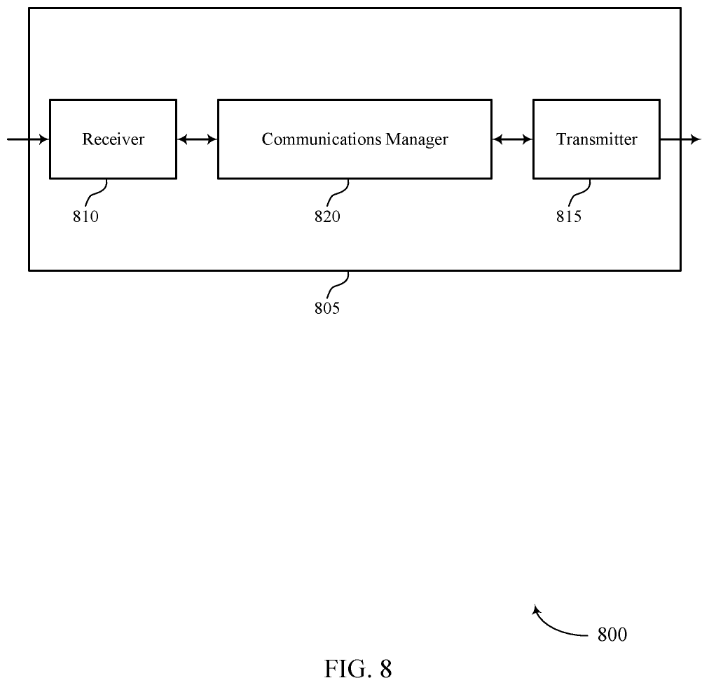

FIG. 8 shows a block diagram 800 of a device 805 that supports collaboration for sensing directional intracell interference in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations or components thereof may be examples of means for performing various aspects of collaboration for sensing directional intracell interference as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for outputting, to a UE, a control message including an indication of one or more resources for measuring directional intracell interference information. The communications manager 820 is capable of, configured to, or operable to support a means for obtaining an intracell interference information report based on one or more directional intracell interference measurements corresponding to the one or more resources. The communications manager 820 is capable of, configured to, or operable to support a means for outputting a beam configuration message including an instruction to perform null steering for one or more beams based on the intracell interference information report.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for more efficient utilization of communication resources and the like.

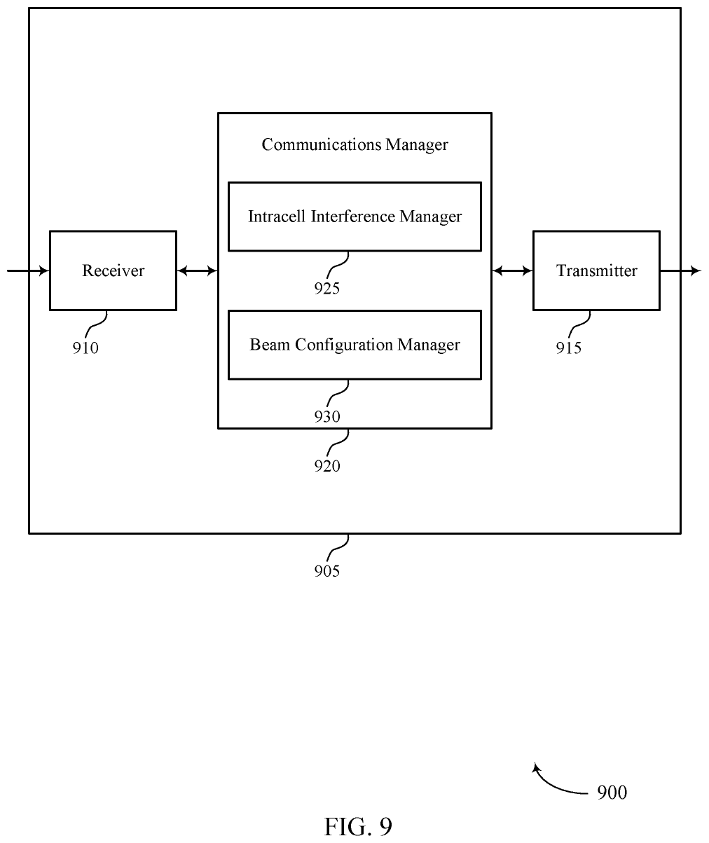

FIG. 9 shows a block diagram 900 of a device 905 that supports collaboration for sensing directional intracell interference in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of collaboration for sensing directional intracell interference as described herein. For example, the communications manager 920 may include an intracell interference manager 925 a beam configuration manager 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The intracell interference manager 925 is capable of, configured to, or operable to support a means for outputting, to a UE, a control message including an indication of one or more resources for measuring directional intracell interference information. The intracell interference manager 925 is capable of, configured to, or operable to support a means for obtaining an intracell interference information report based on one or more directional intracell interference measurements corresponding to the one or more resources. The beam configuration manager 930 is capable of, configured to, or operable to support a means for outputting a beam configuration message including an instruction to perform null steering for one or more beams based on the intracell interference information report.

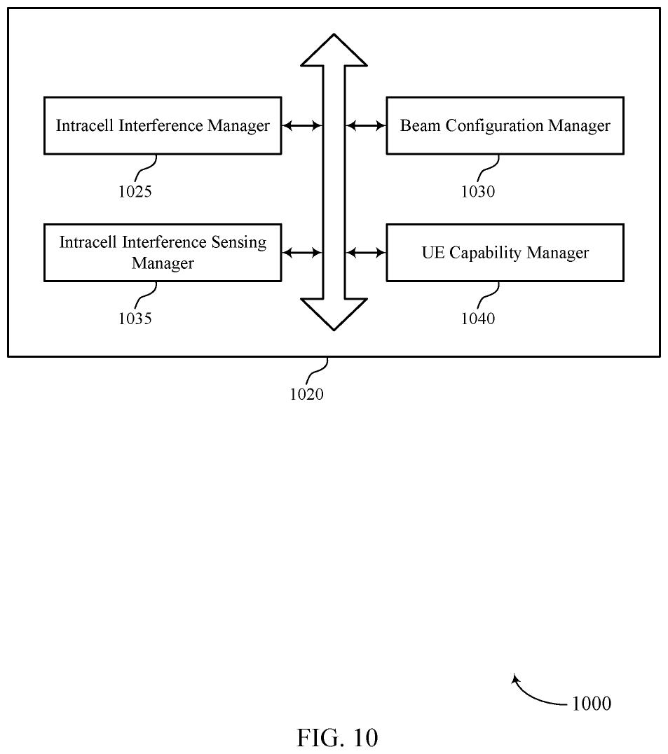

FIG. 10 shows a block diagram 1000 of a communications manager 1020 that supports collaboration for sensing directional intracell interference in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of collaboration for sensing directional intracell interference as described herein. For example, the communications manager 1020 may include an intracell interference manager 1025, a beam configuration manager 1030, an intracell interference sensing manager 1035, a UE capability manager 1040, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications in accordance with examples as disclosed herein. The intracell interference manager 1025 is capable of, configured to, or operable to support a means for outputting, to a UE, a control message including an indication of one or more resources for measuring directional intracell interference information. In some examples, the intracell interference manager 1025 is capable of, configured to, or operable to support a means for obtaining an intracell interference information report based on one or more directional intracell interference measurements corresponding to the one or more resources. The beam configuration manager 1030 is capable of, configured to, or operable to support a means for outputting a beam configuration message including an instruction to perform null steering for one or more beams based on the intracell interference information report.

In some examples, the intracell interference sensing manager 1035 is capable of, configured to, or operable to support a means for sensing for directional intracell interference associated with one or more UEs based on the intracell interference information report, where the beam configuration message is based on the sensing.

In some examples, the intracell interference manager 1025 is capable of, configured to, or operable to support a means for outputting, via the control message, an instruction for the UE to perform DOA measurements via the one or more resources for measuring directional intracell interference information.

In some examples, the intracell interference manager 1025 is capable of, configured to, or operable to support a means for obtaining, via the intracell interference information report, an indication of an estimated DOA according to the DOA measurements, where the beam configuration message is based on the estimated DOA.

In some examples, the intracell interference manager 1025 is capable of, configured to, or operable to support a means for outputting, via the control message, an indication for the UE to transmit an uplink measurement signal via the one or more resources for measuring directional intracell interference information.

In some examples, the UE capability manager 1040 is capable of, configured to, or operable to support a means for outputting a capability request message including a request for a UE capability report associated with a null steering capability at the UE.

In some examples, the UE capability manager 1040 is capable of, configured to, or operable to support a means for obtaining a UE capability report associated with the null steering capability at the UE according to the capability request message, where outputting the control message including the indication of the one or more resources for measuring directional intracell interference information is based on the UE capability report.

In some examples, the UE capability report includes, a threshold quantity of directions in which the UE is capable of performing null steering. In some examples, the beam configuration message including an instruction to perform null steering for one or more beams is based on the threshold quantity of directions.

In some examples, the UE capability report includes, a threshold width of a candidate null steered beam. In some examples, the beam configuration message including an instruction to perform null steering for one or more beams is based on the threshold width.

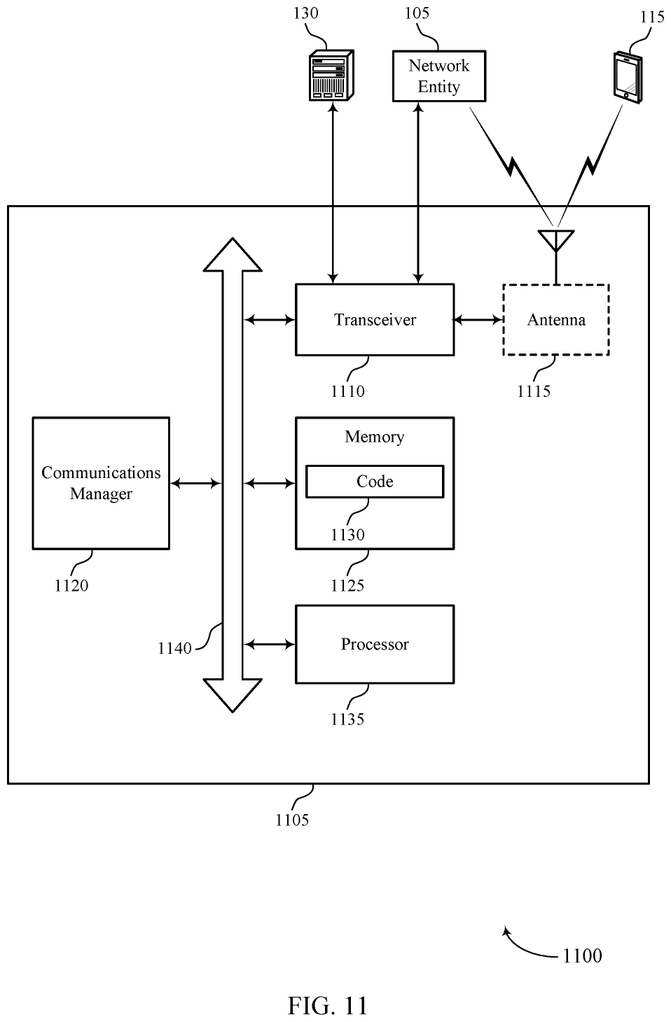

FIG. 11 shows a diagram of a system 1100 including a device 1105 that supports collaboration for sensing directional intracell interference in accordance with one or more aspects of the present disclosure. The device 1105 may be an example of or include components of a device 805, a device 905, or a network entity 105 as described herein. The device 1105 may communicate with other network devices or network equipment such as one or more of the network entities 105, UEs 115, or any combination thereof. The communications may include communications over one or more wired interfaces, over one or more wireless interfaces, or any combination thereof. The device 1105 may include components that support outputting and obtaining communications, such as a communications manager 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may include, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include one or more intelligent hardware devices (e.g., one or more general-purpose processors, one or more DSPs, one or more central processing units (CPUs), one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting collaboration for sensing directional intracell interference). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125). In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with one or more other network devices 105, and may include a controller or scheduler for controlling communications with UEs 115 (e.g., in cooperation with the one or more other network devices). In some examples, the communications manager 1120 may support an X2 interface within an LTE/LTE-A wireless communications network technology to provide communication between network entities 105.

The communications manager 1120 may support wireless communications in accordance with examples as disclosed herein. For example, the communications manager 1120 is capable of, configured to, or operable to support a means for outputting, to a UE, a control message including an indication of one or more resources for measuring directional intracell interference information. The communications manager 1120 is capable of, configured to, or operable to support a means for obtaining an intracell interference information report based on one or more directional intracell interference measurements corresponding to the one or more resources. The communications manager 1120 is capable of, configured to, or operable to support a means for outputting a beam configuration message including an instruction to perform null steering for one or more beams based on the intracell interference information report.

By including or configuring the communications manager 1120 in accordance with examples as described herein, the device 1105 may support techniques for improved communication reliability, reduced latency, more efficient utilization of communication resources, improved coordination between devices, and the like.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of collaboration for sensing directional intracell interference as described herein, or the at least one processor 1135 and the at least one memory 1125 may be otherwise configured to, individually or collectively, perform or support such operations.

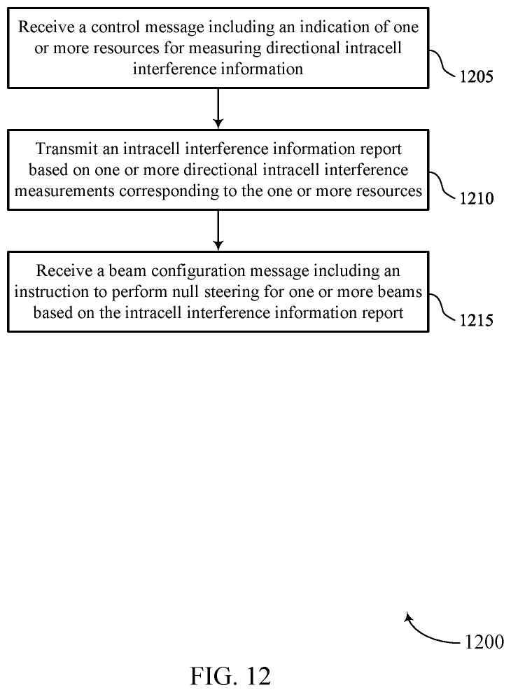

FIG. 12 shows a flowchart illustrating a method 1200 that supports collaboration for sensing directional intracell interference in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving a control message including an indication of one or more resources for measuring directional intracell interference information. The operations of 1205 may be performed in accordance with examples as disclosed herein. In some examples, aspects of the operations of 1205 may be performed by a DOA estimation component 625 as described with reference to FIG. 6.

At 1210, the method may include transmitting an intracell interference information report based on one or more directional intracell interference measurements corresponding to the one or more resources. The operations of 1210 may be performed in accordance with examples as disclosed herein. In some examples, aspects of the operations of 1210 may be performed by a DOA estimation component 625 as described with reference to FIG. 6.

At 1215, the method may include receiving a beam configuration message including an instruction to perform null steering for one or more beams based on the intracell interference information report. The operations of 1215 may be performed in accordance with examples as disclosed herein. In some examples, aspects of the operations of 1215 may be performed by a beam configuration component 630 as described with reference to FIG. 6.

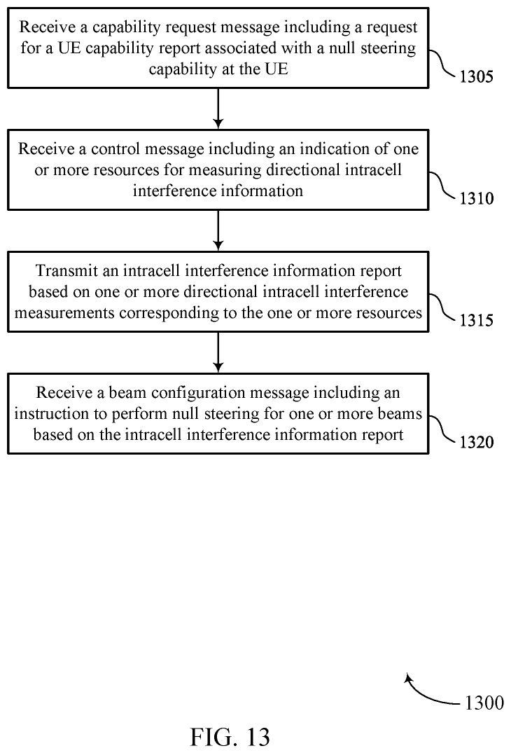

FIG. 13 shows a flowchart illustrating a method 1300 that supports collaboration for sensing directional intracell interference in accordance with one or more aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include receiving a capability request message including a request for a UE capability report associated with a null steering capability at the UE. The operations of 1305 may be performed in accordance with examples as disclosed herein. In some examples, aspects of the operations of 1305 may be performed by a UE capability component 635 as described with reference to FIG. 6.

At 1310, the method may include receiving a control message including an indication of one or more resources for measuring directional intracell interference information. The operations of 1310 may be performed in accordance with examples as disclosed herein. In some examples, aspects of the operations of 1310 may be performed by a DOA estimation component 625 as described with reference to FIG. 6.

At 1315, the method may include transmitting an intracell interference information report based on one or more directional intracell interference measurements corresponding to the one or more resources. The operations of 1315 may be performed in accordance with examples as disclosed herein. In some examples, aspects of the operations of 1315 may be performed by a DOA estimation component 625 as described with reference to FIG. 6.

At 1320, the method may include receiving a beam configuration message including an instruction to perform null steering for one or more beams based on the intracell interference information report. The operations of 1320 may be performed in accordance with examples as disclosed herein. In some examples, aspects of the operations of 1320 may be performed by a beam configuration component 630 as described with reference to FIG. 6.

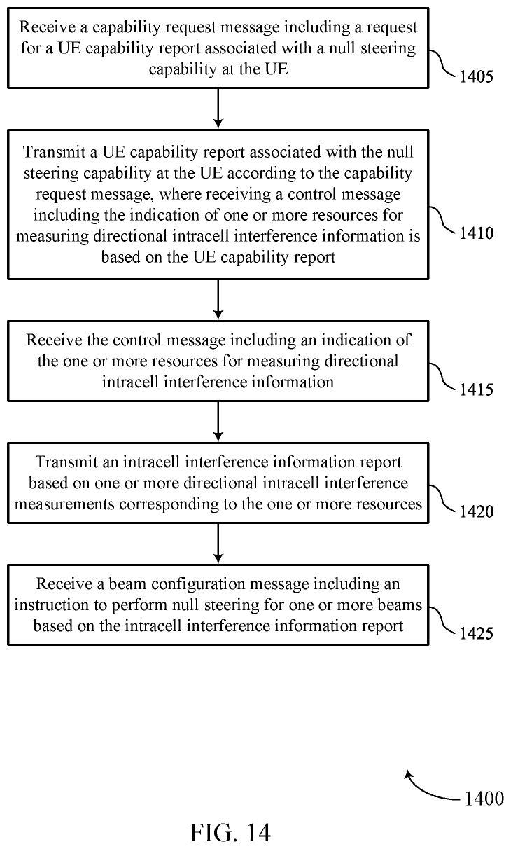

FIG. 14 shows a flowchart illustrating a method 1400 that supports collaboration for sensing directional intracell interference in accordance with one or more aspects of the present disclosure. The operations of the method 1400 may be implemented by a UE or its components as described herein. For example, the operations of the method 1400 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1405, the method may include receiving a capability request message including a request for a UE capability report associated with a null steering capability at the UE. The operations of 1405 may be performed in accordance with examples as disclosed herein. In some examples, aspects of the operations of 1405 may be performed by a UE capability component 635 as described with reference to FIG. 6.

At 1410, the method may include transmitting a UE capability report associated with the null steering capability at the UE according to the capability request message, where receiving a control message including the indication of one or more resources for measuring directional intracell interference information is based on the UE capability report. The operations of 1410 may be performed in accordance with examples as disclosed herein. In some examples, aspects of the operations of 1410 may be performed by a UE capability component 635 as described with reference to FIG. 6.

At 1415, the method may include receiving the control message including an indication of the one or more resources for measuring directional intracell interference information. The operations of 1415 may be performed in accordance with examples as disclosed herein. In some examples, aspects of the operations of 1415 may be performed by a DOA estimation component 625 as described with reference to FIG. 6.

At 1420, the method may include transmitting an intracell interference information report based on one or more directional intracell interference measurements corresponding to the one or more resources. The operations of 1420 may be performed in accordance with examples as disclosed herein. In some examples, aspects of the operations of 1420 may be performed by a DOA estimation component 625 as described with reference to FIG. 6.

At 1425, the method may include receiving a beam configuration message including an instruction to perform null steering for one or more beams based on the intracell interference information report. The operations of 1425 may be performed in accordance with examples as disclosed herein. In some examples, aspects of the operations of 1425 may be performed by a beam configuration component 630 as described with reference to FIG. 6.

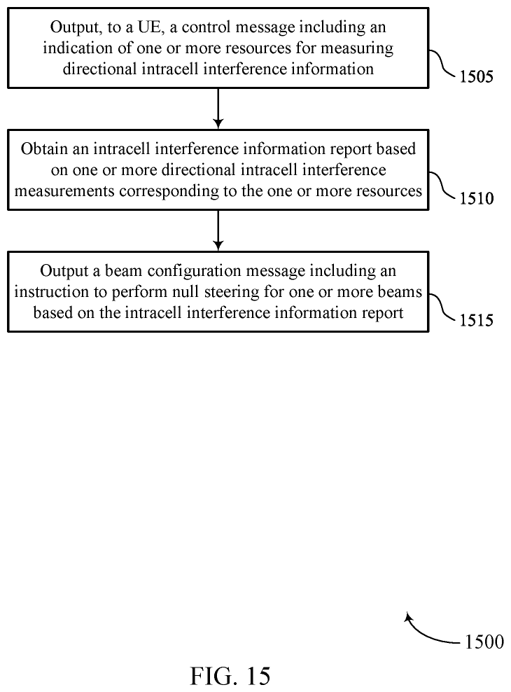

FIG. 15 shows a flowchart illustrating a method 1500 that supports collaboration for sensing directional intracell interference in accordance with one or more aspects of the present disclosure. The operations of the method 1500 may be implemented by a network entity or its components as described herein. For example, the operations of the method 1500 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1505, the method may include outputting, to a UE, a control message including an indication of one or more resources for measuring directional intracell interference information. The operations of 1505 may be performed in accordance with examples as disclosed herein. In some examples, aspects of the operations of 1505 may be performed by an intracell interference manager 1025 as described with reference to FIG. 10.

At 1510, the method may include obtaining an intracell interference information report based on one or more directional intracell interference measurements corresponding to the one or more resources. The operations of 1510 may be performed in accordance with examples as disclosed herein. In some examples, aspects of the operations of 1510 may be performed by an intracell interference manager 1025 as described with reference to FIG. 10.

At 1515, the method may include outputting a beam configuration message including an instruction to perform null steering for one or more beams based on the intracell interference information report. The operations of 1515 may be performed in accordance with examples as disclosed herein. In some examples, aspects of the operations of 1515 may be performed by a beam configuration manager 1030 as described with reference to FIG. 10.

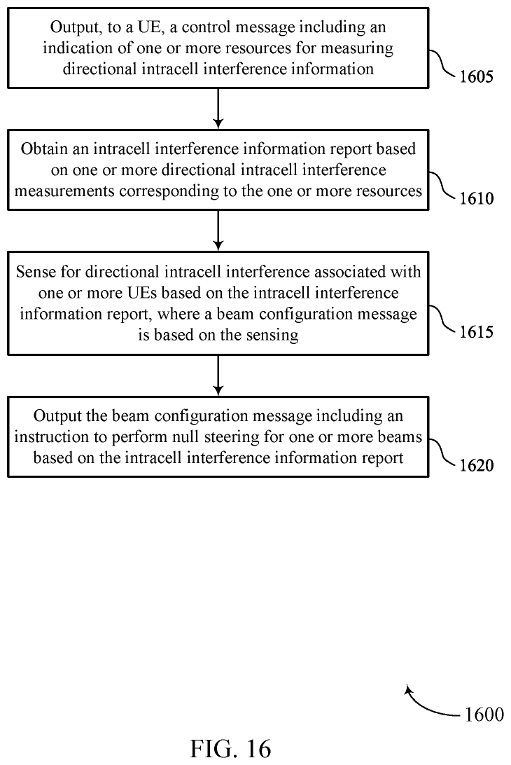

FIG. 16 shows a flowchart illustrating a method 1600 that supports collaboration for sensing directional intracell interference in accordance with one or more aspects of the present disclosure. The operations of the method 1600 may be implemented by a network entity or its components as described herein. For example, the operations of the method 1600 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1605, the method may include outputting, to a UE, a control message including an indication of one or more resources for measuring directional intracell interference information. The operations of 1605 may be performed in accordance with examples as disclosed herein. In some examples, aspects of the operations of 1605 may be performed by an intracell interference manager 1025 as described with reference to FIG. 10.

At 1610, the method may include obtaining an intracell interference information report based on one or more directional intracell interference measurements corresponding to the one or more resources. The operations of 1610 may be performed in accordance with examples as disclosed herein. In some examples, aspects of the operations of 1610 may be performed by an intracell interference manager 1025 as described with reference to FIG. 10.

At 1615, the method may include sensing for directional intracell interference associated with one or more UEs based on the intracell interference information report, where a beam configuration message is based on the sensing. The operations of 1615 may be performed in accordance with examples as disclosed herein. In some examples, aspects of the operations of 1615 may be performed by an intracell interference sensing manager 1035 as described with reference to FIG. 10.

At 1620, the method may include outputting the beam configuration message including an instruction to perform null steering for one or more beams based on the intracell interference information report. The operations of 1620 may be performed in accordance with examples as disclosed herein. In some examples, aspects of the operations of 1620 may be performed by a beam configuration manager 1030 as described with reference to FIG. 10.

The following provides an overview of aspects of the present disclosure:

Aspect 1: A method for wireless communications at a UE, comprising: receiving a control message comprising an indication of one or more resources for measuring directional intracell interference information; transmitting an intracell interference information report based at least in part on one or more directional intracell interference measurements corresponding to the one or more resources; and receiving a beam configuration message comprising an instruction to perform null steering for one or more beams based at least in part on the intracell interference information report.

Aspect 2: The method of aspect 1, further comprising: receiving, via the control message, an instruction for the UE to perform DOA measurements via the one or more resources for measuring directional intracell interference information.

Aspect 3: The method of aspect 2, further comprising: detecting an uplink measurement signal transmitted by a second UE via the one or more resources for measuring directional intracell interferences information; and performing the one or more directional intracell interference measurements comprising the DOA measurements according to the instruction for the UE to perform the DOA measurements and based at least in part on detecting the uplink measurement signal.

Aspect 4: The method of aspect 3, further comprising: transmitting, via the intracell interference information report, an indication of an estimated DOA associated with the uplink measurement signal according to the DOA measurements, wherein the beam configuration message is based at least in part on the estimated DOA.

Aspect 5: The method of any of aspects 1, further comprising: receiving, via the control message, an indication for the UE to transmit an uplink measurement signal via the one or more resources for measuring directional intracell interference information; and transmitting the uplink measurement signal via the one or more resources for measuring directional intracell interference information, wherein the one or more directional intracell interference measurements are based at least in part on the uplink measurement signal.

Aspect 6: The method of any of aspects 1 through 5, further comprising: receiving a capability request message comprising a request for a UE capability report associated with a null steering capability at the UE.

Aspect 7: The method of aspect 6, further comprising: transmitting a UE capability report associated with the null steering capability at the UE according to the capability request message, wherein receiving the control message comprising the indication of the one or more resources for measuring directional intracell interference information is based at least in part on the UE capability report.

Aspect 8: The method of aspect 7, wherein the UE capability report comprises a threshold quantity of directions in which the UE is capable of performing null steering, and the beam configuration message comprising an instruction to perform null steering for the one or more beams is based at least in part on the threshold quantity of directions.

Aspect 9: The method of any of aspects 7 through 8, wherein the UE capability report comprises a threshold width of a candidate null steered beam, the beam configuration message comprising an instruction to perform null steering for the one or more beams is based at least in part on the threshold width.

Aspect 10: The method of any of aspects 1 through 9, further comprising: performing null steering for the one or more beams based at least in part on the intracell interference information report.

Aspect 11: A method for wireless communications at a network entity, comprising: outputting, to a UE, a control message comprising an indication of one or more resources for measuring directional intracell interference information; obtaining an intracell interference information report based at least in part on one or more directional intracell interference measurements corresponding to the one or more resources; and outputting a beam configuration message comprising an instruction to perform null steering for one or more beams based at least in part on the intracell interference information report.

Aspect 12: The method of aspect 11, further comprising: sensing for directional intracell interference associated with one or more UEs based at least in part on the intracell interference information report, wherein the beam configuration message is based at least in part on the sensing.

Aspect 13: The method of any of aspects 11 through 12, further comprising: outputting, via the control message, an instruction for the UE to perform DOA measurements via the one or more resources for measuring directional intracell interference information.

Aspect 14: The method of aspect 13, further comprising: obtaining, via the intracell interference information report, an indication of an estimated DOA according to the DOA measurements, wherein the beam configuration message is based at least in part on the estimated DOA.

Aspect 15: The method of any of aspects 11 through 12, further comprising: outputting, via the control message, an indication for the UE to transmit an uplink measurement signal via the one or more resources for measuring directional intracell interference information.

Aspect 16: The method of any of aspects 11 through 15, further comprising: outputting a capability request message comprising a request for a UE capability report associated with a null steering capability at the UE.

Aspect 17: The method of aspect 16, further comprising: obtaining a UE capability report associated with the null steering capability at the UE according to the capability request message, wherein outputting the control message comprising the indication of the one or more resources for measuring directional intracell interference information is based at least in part on the UE capability report.

Aspect 18: The method of aspect 17, wherein the UE capability report comprises, a threshold quantity of directions in which the UE is capable of performing null steering, and the beam configuration message comprising an instruction to perform null steering for one or more beams is based at least in part on the threshold quantity of directions.

Aspect 19: The method of any of aspects 17 through 18, wherein the UE capability report comprises, a threshold width of a candidate null steered beam, the beam configuration message comprising an instruction to perform null steering for one or more beams is based at least in part on the threshold width.

Aspect 20: A UE for wireless communications, comprising one or more memories storing processor-executable code, and one or more processors coupled with the one or more memories and individually or collectively operable to execute the code to cause the UE to perform a method of any of aspects 1 through 10.

Aspect 21: A UE for wireless communications, comprising at least one means for performing a method of any of aspects 1 through 10.

Aspect 22: A non-transitory computer-readable medium storing code for wireless communications, the code comprising instructions executable by one or more processors to perform a method of any of aspects 1 through 10.

Aspect 23: A network entity for wireless communications, comprising one or more memories storing processor-executable code, and one or more processors coupled with the one or more memories and individually or collectively operable to execute the code to cause the network entity to perform a method of any of aspects 11 through 19.

Aspect 24: A network entity for wireless communications, comprising at least one means for performing a method of any of aspects 11 through 19.

Aspect 25: A non-transitory computer-readable medium storing code for wireless communications, the code comprising instructions executable by one or more processors to perform a method of any of aspects 11 through 19.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a control message comprising an indication of one or more resources for measuring directional intracell interference information;
transmit an intracell interference information report based at least in part on one or more directional intracell interference measurements corresponding to the one or more resources; and
receive a beam configuration message comprising an instruction to perform null steering for one or more beams based at least in part on the intracell interference information report.

2. The UE of claim 1, wherein the one or more processors are individually or collectively further operable to execute the code to cause the UE to:
receive, via the control message, an instruction for the UE to perform direction of arrival measurements via the one or more resources for measuring directional intracell interference information.

3. The UE of claim 2, wherein the one or more processors are individually or collectively further operable to execute the code to cause the UE to:
detect an uplink measurement signal transmitted by a second UE via the one or more resources for measuring directional intracell interferences information; and
perform the one or more directional intracell interference measurements comprising the direction of arrival measurements according to the instruction for the UE to perform the direction of arrival measurements and based at least in part on detecting the uplink measurement signal.

4. The UE of claim 3, wherein the one or more processors are individually or collectively further operable to execute the code to cause the UE to:
transmit, via the intracell interference information report, an indication of an estimated direction of arrival associated with the uplink measurement signal according to the direction of arrival measurements, wherein the beam configuration message is based at least in part on the estimated direction of arrival.

5. The UE of claim 1, wherein the one or more processors are individually or collectively further operable to execute the code to cause the UE to:
receive, via the control message, an indication for the UE to transmit an uplink measurement signal via the one or more resources for measuring directional intracell interference information; and
transmit the uplink measurement signal via the one or more resources for measuring directional intracell interference information, wherein the one or more directional intracell interference measurements are based at least in part on the uplink measurement signal.

6. The UE of claim 1, wherein the one or more processors are individually or collectively further operable to execute the code to cause the UE to:
receive a capability request message comprising a request for a UE capability report associated with a null steering capability at the UE.

7. The UE of claim 6, wherein the one or more processors are individually or collectively further operable to execute the code to cause the UE to:
transmit a UE capability report associated with the null steering capability at the UE according to the capability request message, wherein receiving the control message comprising the indication of the one or more resources for measuring directional intracell interference information is based at least in part on the UE capability report.

8. The UE of claim 7, wherein:
the UE capability report comprises a threshold quantity of directions in which the UE is capable of performing null steering, and
the beam configuration message comprising an instruction to perform null steering for the one or more beams is based at least in part on the threshold quantity of directions.

9. The UE of claim 7, wherein:
the UE capability report comprises a threshold width of a candidate null steered beam, and
the beam configuration message comprising an instruction to perform null steering for the one or more beams is based at least in part on the threshold width.

10. The UE of claim 1, wherein the one or more processors are individually or collectively further operable to execute the code to cause the UE to:
perform null steering for the one or more beams based at least in part on the intracell interference information report.

11. A network entity, comprising:
one or more memories storing processor-executable code; and
one or more processors coupled with the one or more memories and individually or collectively operable to execute the code to cause the network entity to:
output, to a user equipment (UE), a control message comprising an indication of one or more resources for measuring directional intracell interference information;
obtain an intracell interference information report based at least in part on one or more directional intracell interference measurements corresponding to the one or more resources; and
output a beam configuration message comprising an instruction to perform null steering for one or more beams based at least in part on the intracell interference information report.

12. The network entity of claim 11, wherein the one or more processors are individually or collectively further operable to execute the code to cause the network entity to:
sense for directional intracell interference associated with one or more UEs based at least in part on the intracell interference information report, wherein the beam configuration message is based at least in part on the sensing.

13. The network entity of claim 11, wherein the one or more processors are individually or collectively further operable to execute the code to cause the network entity to:
output, via the control message, an instruction for the UE to perform direction of arrival measurements via the one or more resources for measuring directional intracell interference information.

14. The network entity of claim 13, wherein the one or more processors are individually or collectively further operable to execute the code to cause the network entity to:
obtain, via the intracell interference information report, an indication of an estimated direction of arrival according to the direction of arrival measurements, wherein the beam configuration message is based at least in part on the estimated direction of arrival.

15. The network entity of claim 11, wherein the one or more processors are individually or collectively further operable to execute the code to cause the network entity to:
output, via the control message, an indication for the UE to transmit an uplink measurement signal via the one or more resources for measuring directional intracell interference information.

16. The network entity of claim 11, wherein the one or more processors are individually or collectively further operable to execute the code to cause the network entity to:
output a capability request message comprising a request for a UE capability report associated with a null steering capability at the UE.

17. The network entity of claim 16, wherein the one or more processors are individually or collectively further operable to execute the code to cause the network entity to:
obtain a UE capability report associated with the null steering capability at the UE according to the capability request message, wherein outputting the control message comprising the indication of the one or more resources for measuring directional intracell interference information is based at least in part on the UE capability report.

18. The network entity of claim 17, wherein:
the UE capability report comprises, a threshold quantity of directions in which the UE is capable of performing null steering, and
the beam configuration message comprising an instruction to perform null steering for one or more beams is based at least in part on the threshold quantity of directions.

19. The network entity of claim 17, wherein:
the UE capability report comprises, a threshold width of a candidate null steered beam, and
the beam configuration message comprising an instruction to perform null steering for one or more beams is based at least in part on the threshold width.

20. A method for wireless communications at a user equipment (UE), comprising:
receiving a control message comprising an indication of one or more resources for measuring directional intracell interference information;
transmitting an intracell interference information report based at least in part on one or more directional intracell interference measurements corresponding to the one or more resources; and
receiving a beam configuration message comprising an instruction to perform null steering for one or more beams based at least in part on the intracell interference information report.
